(19) United States
(12) Patent Application Publication
(10) Pub. No.: US 2025/0334487 A1
(43) Pub. Date: Oct. 30, 2025

(54) SYSTEM AND METHOD FOR MONITORING TENSION IN TRACK OF WORK MACHINE

(71) Applicant: Caterpillar Inc., Peoria, IL (US)

(72) Inventors: Ramesh Krishnasamy, Dunlap, IL (US); Ranjit Singh, Peoria, IL (US); Solimar Reyes-Rodriguez, Edwards, IL (US); John Bender, East Peoria, IL (US); Li Zhang, Dunlap, IL (US); Hamza Soury, Peoria, IL (US)

(73) Assignee: Caterpillar Inc., Peoria, IL (US)

(21) Appl. No.: 18/645,702

(22) Filed: Apr. 25, 2024

(51) Int. Cl. G01M 17/03; G01S 13/08

(52) U.S. Cl. CPC G01M 17/03; G01S 13/08

(57) ABSTRACT

A system for monitoring a tension in a track of a work machine includes one or more sensors coupled to the work machine. A sensor, of the one or more sensors, is configured to obtain a distance information related to a distance between the sensor and the track of the work machine. The sensor includes a pulse Radio Detection and Ranging (RADAR) sensor. The system includes a controller including at least one memory and at least one processor. The memory is configured to store an expected distance between the sensor and the track of the work machine. The processor is configured to determine an actual distance between the sensor and the track of the work machine, based on the distance information obtained from the sensor and determine, based on the actual distance being greater than the expected distance, that the tension in the track is below a tension threshold.

### TECHNICAL FIELD

The present disclosure relates to a system and a method for monitoring a tension in a track of a work machine.

### BACKGROUND

A variety of machines, particularly those used in the mining and construction industries, include an undercarriage system for moving the machines on grounds. The undercarriage system includes a pair of tracks. Each track loops around two or more wheels or rollers, and a surface area of the tracks help to distribute a weight of the machine.

Performance of tracks are significantly affected by a tension in the tracks. The tracks are coupled to the machine at an optimum track tension, so as to prevent wear of the components of the undercarriage system and to promote a longer track life. In some cases, the track tension may reduce, which may cause wear of track components and may limit in realizing complete value of the undercarriage system. However, it can be difficult for machine users to know whether the tension in one or both tracks of the machine have reduced.

JP5384228B2 describes a crawler monitoring device capable of detecting and informing any abnormality of a crawler. The profile of a rubber crawler is detected by a camera set mounted on a vehicle traveling by the rubber crawler. Further, a control device mounted on the vehicle determines whether or not the rubber crawler is abnormal based on the detected profile data obtained from the detected profile input from the camera cassette and the reference profile data read by a signal receiver provided on the vehicle from an IC tag provided on the rubber crawler. When it is determined that the rubber crawler is abnormal, an alarm is generated by a display or a speaker mounted on the vehicle.

### SUMMARY OF THE DISCLOSURE

In an aspect of the present disclosure, a system for monitoring a tension in a track of a work machine is provided. The system includes one or more sensors coupled to the work machine. A sensor, of the one or more sensors, is configured to obtain a distance information related to a distance between the sensor and the track of the work machine. The sensor includes a pulse radio detection and ranging (RADAR) sensor. The system also includes a controller including at least one memory and at least one processor communicably coupled with the memory and the sensor. The memory is configured to store an expected distance between the sensor and the track of the work machine. The processor is configured to determine an actual distance between the sensor and the track of the work machine, based on the distance information obtained from the sensor. The processor is also configured to determine, based on the actual distance being greater than the expected distance, that the tension in the track is below a tension threshold.

In another aspect of the present disclosure, a system for monitoring a tension in a track of a work machine. The system includes one or more sensors coupled to the work machine. A sensor, of the one or more sensors, is configured to obtain an information related to a decrease in the tension in the track. The sensor includes a laser displacement sensor, an ultrasound sensor, an imaging device, an inductive position sensor, or a linear position sensor associated with an actuator of the work machine that is adapted to adjust the tension in the track. The system also includes a controller including at least one memory and at least one processor communicably coupled with the memory and the sensor. The processor is configured to analyze the information related to the decrease in the tension in the track obtained from the sensor. The processor is also configured to determine, based on an analysis of the information obtained from the sensor, that the tension in the track is below a tension threshold.

In yet another aspect of the present disclosure, a method for monitoring a tension in a track of a work machine is provided. The method includes obtaining, by a sensor coupled to the work machine, an information related to a decrease in the tension in the track. The sensor includes a pulse radio detection and ranging (RADAR) sensor, a laser displacement sensor, an ultrasound sensor, an imaging device, an inductive position sensor, or a linear position sensor associated with an actuator of the work machine that is adapted to adjust the tension in the track. The method also includes analyzing, by at least one processor of a controller, the information related to the decrease in the tension in the track obtained from the sensor. The method further includes determining, by the processor, that the tension in the track is below a tension threshold, based on an analysis of the information obtained from the sensor.

Other features and aspects of this disclosure will be apparent from the following description and the accompanying drawings.

### BRIEF DESCRIPTION OF THE DRAWINGS

FIG. 1 illustrates an exemplary work machine having a pair of tracks;

FIG. 2 is a block diagram of a system for monitoring a tension in a track of the work machine of FIG. 1, according to an example of the present disclosure;

FIG. 3 is a schematic representation of the track and sensors of the system of FIG. 2;

FIG. 4 is a flowchart for a process of monitoring the tension in the track of the work machine of FIG. 1 using the system of FIG. 2;

FIG. 5 is a block diagram of a system for monitoring the tension in the track of the work machine of FIG. 1, according to another example of the present disclosure;

FIG. 6 is a schematic representation of the track and sensors of the system of FIG. 5;

FIG. 7 is a side view illustrating sensors of the system of FIG. 5 coupled to an undercarriage system of the work machine of FIG. 1;

FIG. 8 is a flowchart for a process of monitoring the tension in the track of the work machine of FIG. 1 using the system of FIG. 5;

FIG. 9 is a block diagram of the system for monitoring the tension in the track of the work machine of FIG. 1, according to yet another example of the present disclosure;

FIG. 10 is a schematic sectional view of an actuator associated with the undercarriage system of the work machine of FIG. 1;

FIG. 11 is a flowchart for a process of monitoring the tension in the track of the work machine of FIG. 1 using the system of FIG. 9; and

FIG. 12 is a flowchart for a method of monitoring the tension in the track of the work machine of FIG. 1, according to an example of the present disclosure.

### DETAILED DESCRIPTION

Wherever possible, the same reference numbers will be used throughout the drawings to refer to the same or like parts.

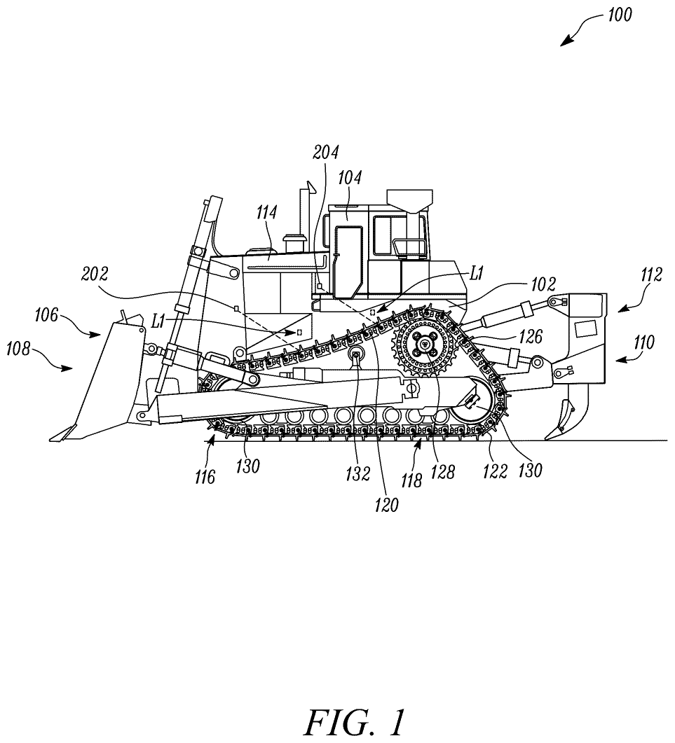

FIG. 1 is a side view of a work machine 100, according to an example of the present disclosure. In the illustrated example of FIG. 1, the work machine 100 is embodied as a track type tractor. In alternate examples, the work machine 100 may include an excavator, a dozer, a harvester, or any other type of machine known in the art having tracks for movement on a ground surface. The work machine 100 may perform one or more machine operations associated with an industry, such as, mining, construction, farming, transportation, or any other industry known in the art. The work machine 100 may be embodied as a manual, autonomous, or semi-autonomous machine, without any limitations.

The work machine 100 includes a frame 102 that supports various machine components thereon. An operator cab 104 is mounted on the frame 102. When the work machine 100 is embodied as a manual or semi-autonomous machine, an operator of the work machine 100 is seated within the operator cab 104 to perform the machine operations. The work machine 100 also includes a work implement 106 coupled at a front end 108 of the work machine 100. The work implement 106 is embodied as a blade. Further, the work machine 100 additionally includes another work implement 110, embodied as a ripper, coupled at a rear end 112 of the work machine 100.

The work machine 100 also includes a power source (not shown) that generates power. The power source may be an engine, a battery system, a fuel cell, and the like. The power source is mounted on the frame 102 for providing propulsion power to the work machine 100. More particularly, the power source is mounted within an enclosure 114 formed in the frame 102.

The work machine 100 further includes an undercarriage system 116. The frame 102 supports the undercarriage system 116. The undercarriage system 116 includes a pair of tracks 118 disposed at either sides of the work machine 100. Only one track 118 is visible in FIG. 1. The tracks 118 rotate in order to propel the work machine 100 on ground surfaces. Further, each track 118 includes a chain assembly 120 and a traction assembly 122. The traction assembly 122 includes a number of track shoes secured to the chain assembly 120.

The undercarriage system 116 also includes a drive sprocket 126 and a driving mechanism 128 coupled to the drive sprocket 126. The tracks 118 are operatively coupled to the driving mechanism 128 by the drive sprocket 126. The undercarriage system 116 also includes a pair of idlers 130 and a roller 132.

The chain assembly 120 may form a continuous chain connected around outer portions of the drive sprocket 126, the idlers 130, and the roller 132. The traction assembly 122 is connected to an outer portion of the chain assembly 120 and engages the ground surface beneath the work machine 100. In use, rotation of the drive sprocket 126 may cause the chain assembly 120 to move around the drive sprocket 126, the idlers 130, and the roller 132, causing the traction assembly 122 to engage the ground surface, and thereby propel the work machine 100 in a manner known in the art. The undercarriage system 116 also includes an actuator 134 (shown in FIG. 10). Tension in the track 118 is maintained by the actuator 134. To tension the track 118, the actuator 134 forces the idlers 130 away from each other. The actuator 134 includes a piston 136 (shown in FIG. 10).

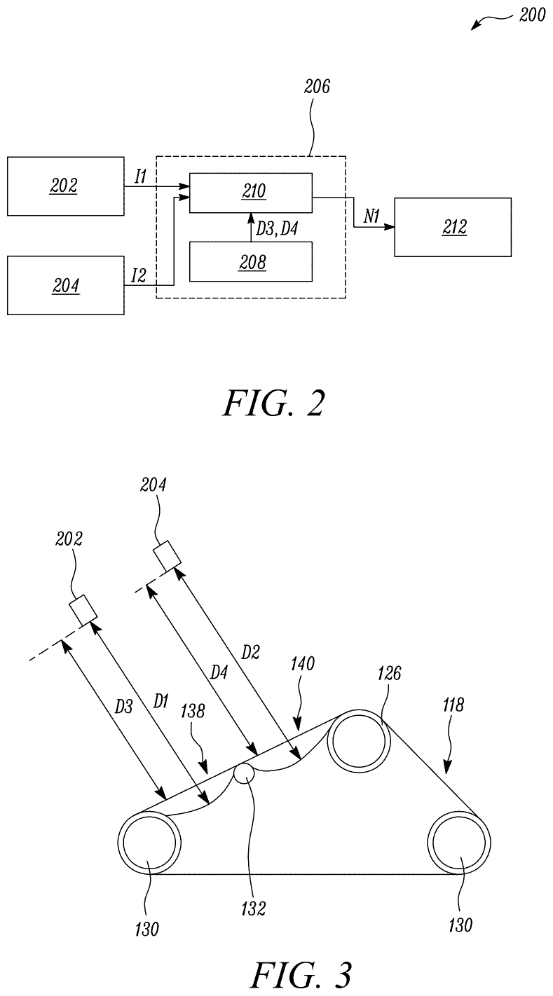

Referring to FIG. 2, the present disclosure relates to a system 200 for monitoring the tension in the track 118 (see FIG. 1) of the work machine 100 (see FIG. 1). It should be noted that the system 200 may be used to monitor the tension in each track 118 of the work machine 100. For exemplary purposes, the system 200 will now be explained in relation to the monitoring of the tension in the track 118 that is visible in FIG. 1.

The system 200 includes one or more sensors 202, 204 coupled to the work machine 100. A sensor 202, 204, of the one or more sensors 202, 204, obtains a distance information I1, I2 related to a distance D1, D2 (shown in FIG. 3) between the sensor 202, 204 and the track 118 of the work machine 100. The sensor 202, 204 includes a pulse radio detection and ranging (RADAR) sensor herein. The pulse RADAR sensor determines a range/distance to a target/component using pulse-timing techniques, and includes a transmitter and a receiver. The sensor 202, 204 is coupled to the frame 102 (see FIG. 1) of the work machine 100. It should be noted that the position of the sensors 202, 204 depicted in FIG. 1 is exemplary in nature. The sensors 202, 204 may also be positioned at locations L1, L2 instead of the locations currently illustrated in FIG. 1. The present disclosure is not limited to the location of the sensors 202, 204 on the work machine 100.

Referring to FIGS. 2 and 3, the sensor 202, 204 may include a first sensor 202 that obtains a first distance information I1 related to a first distance D1 between the first sensor 202 and a first portion 138 of the track 118 of the work machine 100 and/or a second sensor 204 that obtains a second distance information I2 related to a second distance D2 between the second sensor 204 and a second portion 140 of the track 118 of the work machine 100. The first portion 138 is spaced apart from the second portion 140. In the illustrated example of FIG. 2, the one or more sensors 202, 204 includes the first sensor 202 as well as the second sensor 204. Alternatively, the one or more sensors 202, 204 may include any one of the first sensor 202 and the second sensor 204. In the present disclosure, the sensor 202 may be interchangeably referred to as the first sensor 202, the sensor 204 may be interchangeably referred to as the second sensor 204, the distance D1 may be interchangeably referred to as the first distance D1, the distance D2 may be interchangeably referred to as the second distance D2, the distance information I1 may be interchangeably referred to as the first distance information I1, and the distance information I2 may be interchangeably referred to as the second distance information I2.

The system 200 also includes a controller 206. The controller 206 includes one or more memories 208 and one or more processors 210 communicably coupled with the memory 208 and the sensors 202, 204. The memory 208 stores an expected distance D3, D4 between the sensor 202, 204 and the track 118 of the work machine 100. The one or more memories 208 may include any means of storing information, including a hard disk, an optical disk, a floppy disk, ROM (read only memory), RAM (random access memory), PROM (programmable ROM), EEPROM (electrically erasable PROM), or other computer-readable memory media.

It should be noted that the one or more processors 210 may embody a single microprocessor or multiple microprocessors for receiving various input signals and generating output signals. Numerous commercially available microprocessors may perform the functions of the one or more processors 210. Each processor 210 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor 210 may include one or more components that may be operable to execute computer executable instructions or computer code that may be stored and retrieved from the one or more memories 208.

Referring to FIG. 2, the processor 210 obtains the distance information I1, I2 from the sensors 202, 204. Further, the processor 210 determines an actual distance D5, D6, D7 between the sensor 202, 204 and the track 118 of the work machine 100, based on the distance information I1, I2 obtained from the sensor 202, 204. The processor 210 also determines, based on the actual distance D5, D6, D7 being greater than the expected distance D3, D4 (see FIG. 3), that the tension in the track 118 is below a tension threshold. Specifically, the processor 210 retrieves the value of the expected distance D3, D4 from the memories 208. Further, the processor 210 compares the actual distance D5, D6, D7 with the expected distance D3, D4. If the actual distance D5, D6, D7 is greater than the expected distance D3, D4, the processor 210 determines that the tension in the track 118 is below the tension threshold.

In an example, when the sensor 202, 204 includes the first sensor 202 and the second sensor 204, the processor 210 determines a first actual distance D6 between the first sensor 202 and the first portion 138 of the track 118 of the work machine 100, based on the first distance information I1. Further, the processor 210 determines a second actual distance D7 between the second sensor 204 and the second portion 140 of the track 118 of the work machine 100, based on the second distance information I2. In this disclosure, the actual distance D6 will be interchangeably referred to as the first actual distance D6 and the actual distance D7 will be interchangeably referred to as the first actual distance D7.

Furthermore, the processor 210 determines that the tension in the track 118 is below the tension threshold based on the first actual distance D6 being greater than a first expected distance D3 between the sensor 202 and the track 118 of the work machine 100 and/or the second actual distance D7 being greater than a second expected distance D4 between the sensor 204 and the track 118 of the work machine 100. In this disclosure, the expected distance D3 may be interchangeably referred to as the first expected distance D3, and the expected distance D4 may be interchangeably referred to as the second expected distance D4. The first expected distance D3 is an expected distance that is desired to be maintained between the sensor 202 and the first portion 138 of the track 118 of the work machine 100. Moreover, the second expected distance D4 is an expected distance that is desired to be maintained between the sensor 204 and the second portion 140 of the track 118 of the work machine 100. As mentioned above, the first and second expected distances D3, D4 are prestored within the memory 208 of the controller 206.

In another example, when the sensor 202, 204 includes the first sensor 202 and the second sensor 204, the processor 210 determines the actual distance D5 by averaging the first actual distance D6 and the second actual distance D7. Further, the processor 210 determines that the tension in the track 118 is below the tension threshold if the actual distance D5 obtained by averaging the first actual distance D6 and the second actual distance D7 is below the expected distance D3, D4.

The processor 210 also generates a notification N1 to alert an operator that the tension in the track 118 is below the tension threshold. The processor 210 transmits the notification N1 to a user interface 212 to alert the operator regarding a decrease in the tension in the track 118. The user interface 212 may be present in the work machine 100 or may be present at a remote location, such as, a back-office.

In some examples, the processor 210 also determines an amount of the tension in the track 118 based on a value of deviation between the actual distance D5, D6, D7 and the expected distance D3, D4. The processor 210 may display the amount of the tension in the track 118 on the user interface 212.

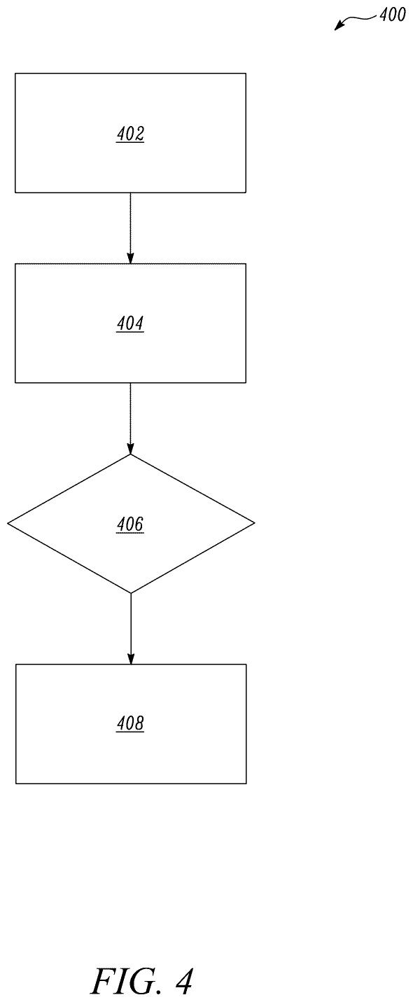

FIG. 4 illustrates a process (or an algorithm) flowchart 400 for monitoring the tension in the track 118 of the work machine 100. The process 400 explains an implementation of the system 200 illustrated in FIG. 2. Referring to FIGS. 1 to 4, the process 400 may be stored in the memory 208 of the controller 206 and retrieved for execution by the processor 210 of the controller 206.

At a block 402, the processor 210 obtains the first distance information I1 related to the first distance D1 between the first sensor 202 and the first portion 138 of the track 118 of the work machine 100 and the second distance information I2 related to the second distance D2 between the second sensor 204 and the second portion 140 of the track 118 of the work machine 100. At a block 404, the processor 210 determines the first actual distance D6 between the first sensor 202 and the first portion 138 of the track 118 of the work machine 100, based on the first distance information I1 and the second actual distance D7 between the second sensor 204 and the second portion 140 of the track 118 of the work machine 100, based on the second distance information I2.

At a block 406, the processor 210 compares the first actual distance D6 with the first expected distance D3 and the second actual distance D7 with the second expected distance D4. The processor 210 determines that the tension in the track 118 is below the tension threshold if the first actual distance D6 is greater than the first expected distance D3 and/or the second actual distance D7 is greater than the second expected distance D4. If the processor 210 determines that the tension in the track 118 is below the tension threshold, the process 400 moves to a block 408 at which the processor 210 generates the notification N1.

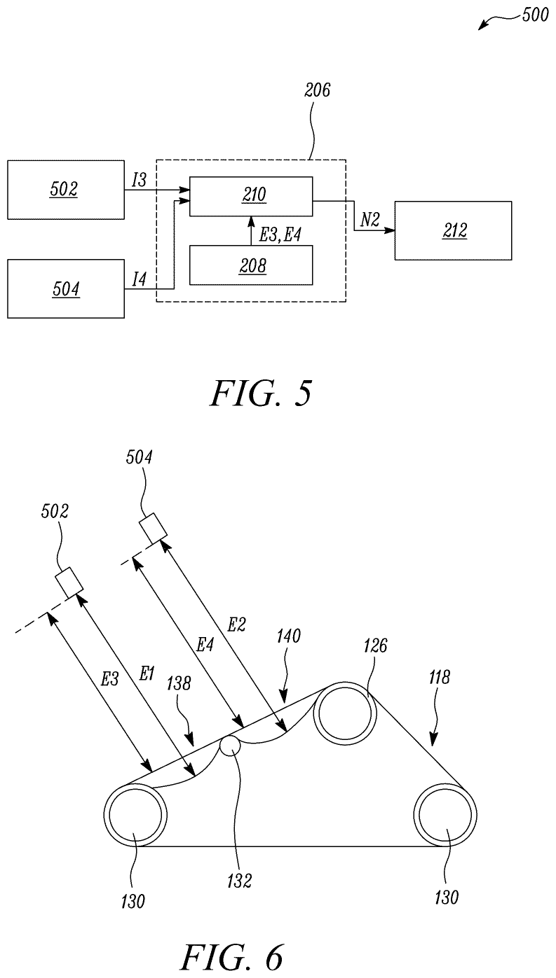

FIG. 5 illustrates a block diagram of a system 500 for monitoring the tension in the track 118 (see FIG. 1) of the work machine 100 (see FIG. 1). The system 500 is substantially similar in functionality to the system 200 described in relation to FIGS. 2 and 3. Same components will be referred to using the same reference numerals. The system 500 includes the controller 206. The controller 206 includes the memory 208 and the processor 210. The system 500 also includes one or more sensors 502, 504 coupled to the work machine 100. A sensor 502, 504, of the one or more sensors 502, 504, obtains an information I3, I4 related to the decrease in the tension in the track 118. The sensor 502, 504 includes a laser displacement sensor, an ultrasound sensor, an imaging device, an inductive position sensor, or a linear position sensor associated with the actuator 134 (see FIG. 10) of the work machine 100 that adjusts the tension in the track 118.

The processor 210 obtains the information I3, I4 related to the decrease in the tension in the track 118 from the sensor 502, 504. Further, the processor 210 analyzes the information I3, I4 related to the decrease in the tension in the track 118 obtained from the sensor 502, 504. Furthermore, the processor 210 determines, based on an analysis of the information I3, I4 obtained from the sensor 502, 504, that the tension in the track 118 is below the tension threshold.

In one example, when the sensor 502, 504 includes the laser displacement sensor, the ultrasound sensor, the imaging device, or the inductive position sensor, the information I3, I4 obtained from the sensor 502, 504 relates to a distance E1, E2 (shown in FIG. 6) between the sensor 502, 504 and the track 118 of the work machine 100. In such an example, the processor 210 determines an actual distance E5, E6, E7 between the sensor 502, 504 and the track 118 of the work machine 100, based on the information I3, I4 obtained from the sensor 502, 504.

Further, when the sensor 502, 504 includes the laser displacement sensor, the sensor 502, 504 obtains the information I3, I4 related to the distance E1, E2 using a triangulation process that is known in the art. Furthermore, when the sensor 502, 504 includes the ultrasound sensor, a type of the ultrasound sensor may be an air coupled transducer. In such an example, the sensor 502, 504 may include a transmitter and a receiver. In the ultrasound sensor, a signal may pass across an interface between two materials and only a proportion of the signal is transmitted, while the rest of the signal is reflected. By analyzing these reflections, the distance E1, E2 between the sensor 502, 504 and the track 118 of the work machine 100 may be measured. The ultrasound sensor may be used in a pulse-echo mode to send and receive the signal.

Further, the processor 210 determines, based on the actual distance E5, E6, E7 being different than an expected distance E3, E4 (shown in FIG. 6) between the sensor 502, 504 and the track 118 of the work machine 100, that the tension in the track 118 is below the tension threshold. The memory 208 is configured to store the expected distance E3, E4 between the sensor 502, 504 and the track 118 of the work machine 100. The processor 210 compares the actual distance E5, E6, E7 with the expected distance E3, E4, to determine the tension in the track 118 is below the tension threshold. It should be noted that, when the sensor 502, 504 includes the laser displacement sensor, the ultrasound sensor, or the imaging device, the processor 210 determines that the tension in the track 118 is below the tension threshold based on the actual distance E5, E6, E7 being greater than the expected distance E3, E4.

Referring to FIGS. 5 and 6, when the sensor 502, 504 includes the laser displacement sensor, the ultrasound sensor, the imaging device, or the inductive position sensor, the sensor 502, 504 may include a first sensor 502 that obtains a first distance information I3 related to a first distance E1 between the first sensor 502 and the first portion 138 of the track 118 of the work machine 100 and/or a second sensor 504 that obtains a second distance information I4 related to a second distance E2 between the second sensor 504 and the second portion 140 of the track 118 of the work machine 100. In the illustrated example of FIG. 2, the one or more sensors 502, 504 includes the first sensor 502 as well as the second sensor 504. Alternatively, the one or more sensors 502, 504 may include any one of the first sensor 502 and the second sensor 504. In the present disclosure, the sensor 502 may be interchangeably referred to as the first sensor 502, the sensor 504 may be interchangeably referred to as the second sensor 504, the distance E1 may be interchangeably referred to as the first distance E1, the distance E2 may be interchangeably referred to as the second distance E2, the distance information I3 may be interchangeably referred to as the first distance information I3, and the distance information I4 may be interchangeably referred to as the second distance information I4.

When the sensor 502, 504 includes the laser displacement sensor, the ultrasound sensor, the imaging device, or the inductive position sensor, the processor 210 determines a first actual distance E6 between the first sensor 502 and the first portion 138 of the track 118 of the work machine 100, based on the first distance information I3. Further, the processor 210 determines a second actual distance E7 between the second sensor 504 and the second portion 140 of the track 118 of the work machine 100, based on the second distance information I4. In the present disclosure, the actual distance E6 will be interchangeably referred to as the first actual distance E6 and the actual distance E7 will be interchangeably referred to as the first actual distance E7.

Furthermore, the processor 210 determines that the tension in the track 118 is below the tension threshold based on the first actual distance E6 being different than a first expected distance E3 between the sensor 502 and the track 118 of the work machine 100 and/or the second actual distance E7 being different than a second expected distance E4 between the sensor 504 and the track 118 of the work machine 100. In the present disclosure, the expected distance E3 may be interchangeably referred to as the first expected distance E3, and the expected distance E4 may be interchangeably referred to as the second expected distance E4. The first expected distance E3 is an expected distance that is desired to be maintained between the sensor 502 and the first portion 138 of the track 118 of the work machine 100. Moreover, the second expected distance E4 is an expected distance that is desired to be maintained between the sensor 504 and the second portion 140 of the track 118 of the work machine 100. As mentioned above, the first and second expected distances E3, E4 are prestored within the memory 208 of the controller 206.

In an example, when the sensor 502, 504 includes the laser displacement sensor, the ultrasound sensor, or the imaging device, the processor 210 determines that the tension in the track 118 is below the tension threshold based on the first actual distance E6 being greater than the first expected distance E3 between the sensor 502 and the track 118 of the work machine 100 and/or the second actual distance E7 being greater than the second expected distance E4 between the sensor 504 and the track 118 of the work machine 100.

In another example, when the sensor 502, 504 includes the first sensor 502 and the second sensor 504, the processor 210 determines the actual distance E5 by averaging the first actual distance E6 and the second actual distance E7. Further, the processor 210 determines that the tension in the track 118 is below the tension threshold if the actual distance E5 obtained by averaging the first actual distance E6 and the second actual distance E7 is greater than the expected distance E3, E4.

It should be noted that when the sensor 502, 504 includes the laser displacement sensor, the ultrasound sensor, the sensor 502, 504 is coupled to the frame 102 (see FIG. 1) of the work machine 100. It should be noted that the position of the sensors 502, 504 may be disposed at a location that is similar to the location of the sensors 202, 204 depicted in FIG. 1. The sensors 502, 504 may also be positioned at the locations L1, L2 instead. The present disclosure is not limited to the location of the sensors 502, 504 on the work machine 100.

As shown in FIGS. 5 and 6, the processor 210 generates a notification N2 to alert the operator that the tension in the track 118 (see FIG. 1) is below the tension threshold. The processor 210 transmits the notification N2 to the user interface 212 to alert the operator regarding the decrease in the tension in the track 118. In some examples, the processor 210 also determines the amount of the tension in the track 118 based on a value of deviation between the actual distance E5, E6, E7 and the expected distance E3, E4. The processor 210 may display the amount of the tension in the track 118 on the user interface 212.

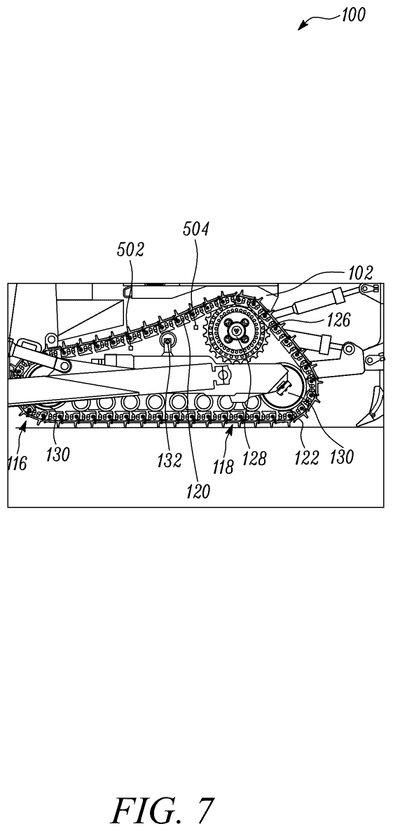

Referring now to FIG. 7, when the sensor 502, 504 includes the inductive position sensor, the sensor 502, 504 is disposed in the undercarriage system 116 of the work machine 100, such that the sensor 502, 504 faces the track 118. Specifically, two sensors 502, 504 are disposed in the undercarriage system 116 of the work machine 100. The sensors 502, 504 are spaced apart from each other. The sensor 502, 504 measure the distance E1, E2 (see FIG. 6) between the sensor 502, 504 and the track 118. Further, when the tension in the track 118 reduces, the distance E1, E2 between the sensor 502, 504 and the track 118 will reduce.

Referring now to FIGS. 5 to 7, in an example, when the sensor 502, 504 includes the inductive position sensor, the processor 210 determines that the tension in the track 118 is below the tension threshold based on the first actual distance E6 being lesser than the first expected distance E3 between the sensor 502 and the track 118 of the work machine 100 and/or the second actual distance E7 being lesser than the second expected distance E4 between the sensor 504 and the track 118 of the work machine 100.

In another example, when the sensor 502, 504 includes the inductive position sensor and when the sensor 502, 504 includes the first sensor 502 and the second sensor 504, the processor 210 determines the actual distance E5 by averaging the first actual distance E6 and the second actual distance E7. Further, the processor 210 determines that the tension in the track 118 is below the tension threshold if the actual distance E5 obtained by averaging the first actual distance E6 and the second actual distance E7 is lesser than the expected distance E3, E4.

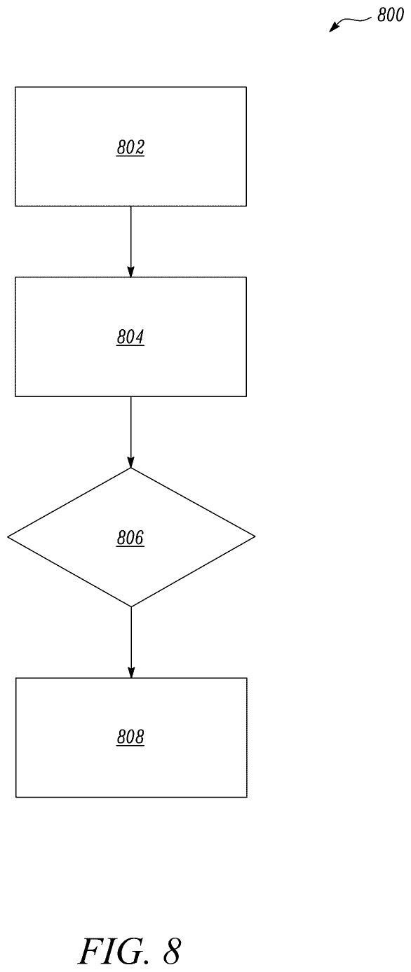

FIG. 8 illustrates a process (or an algorithm) flowchart 800 for monitoring the tension in the track 118 of the work machine 100. The process 800 explains an implementation of the system 500 illustrated in FIG. 2. Referring to FIGS. 5 to 8, the process 800 may be stored in the memory 208 of the controller 206 and retrieved for execution by the processor 210 of the controller 206.

At a block 802, the processor 210 obtains the first distance information I3 related to the first distance E1 between the first sensor 502 and the first portion 138 of the track 118 of the work machine 100 and the second distance information I4 related to the second distance E2 between the second sensor 504 and the second portion 140 of the track 118 of the work machine 100. At a block 804, the processor 210 determines the first actual distance E6 between the first sensor 502 and the first portion 138 of the track 118 of the work machine 100, based on the first distance information I3 and the second actual distance E7 between the second sensor 504 and the second portion 140 of the track 118 of the work machine 100, based on the second distance information I4.

At a block 806, the processor 210 compares the first actual distance E6 with the first expected distance E3 and the second actual distance E7 with the second expected distance E4. The processor 210 determines that the tension in the track 118 is below the tension threshold if the first actual distance E6 is different from the first expected distance E3 and/or the second actual distance E7 is different from the second expected distance E4. If the processor 210 determines that the tension in the track 118 is below the tension threshold, the process 800 moves to a block 808 at which the processor 210 generates the notification N2.

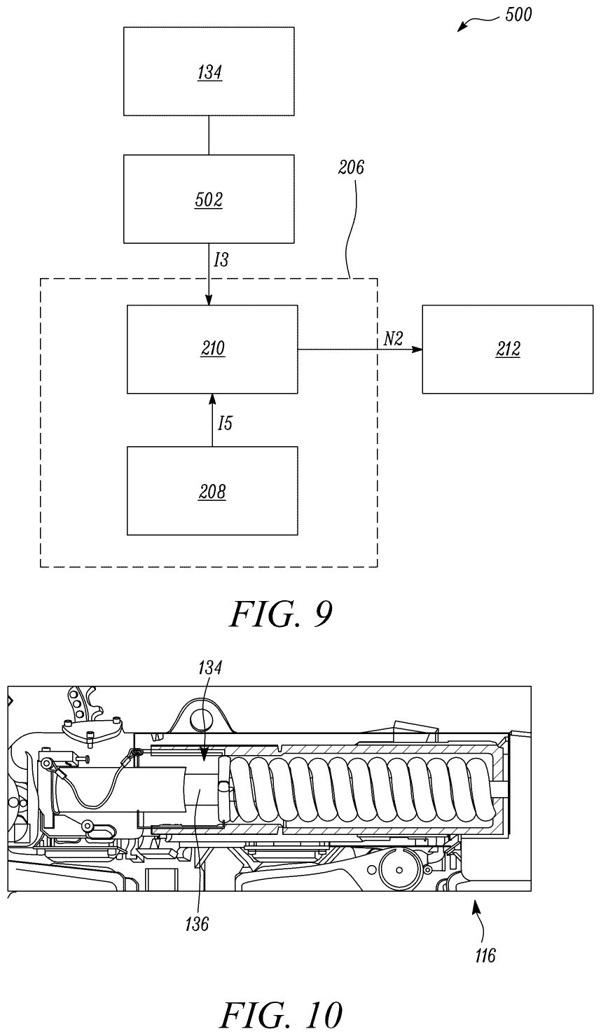

Referring now to FIGS. 9 and 10, when the sensor 502 includes the linear position sensor, the sensor 502 is communicably coupled with the actuator 134. In an example, the sensor 502 may be disposed in the actuator 134. In another example, the sensor 502 may be coupled to the frame 102 (see FIG. 1) or the undercarriage system 116, such that it can sense a position/movement of the piston 136. Only the single sensor 502 is illustrated herein. However, the system 500 may include two sensors instead of the single sensor 502. Further, the linear position sensor may be embodied as an in-cylinder position sensor.

When the sensor 502 includes the linear position sensor, the information I3 obtained from the sensor 502 is related to a movement of the piston 136 from its previous position. In an example, the information I3 may provide a current position of the piston 136 relative to the sensor 502.

Further, when the sensor 502 includes the linear position sensor, the processor 210 determines that the tension in the track 118 is below the tension threshold based on the movement of the piston 136 from its previous position. The piston 136 may move if there is a leak in the undercarriage system 116 or based on a manual adjustment of the amount of grease/oil in the actuator 134. The processor 210 may obtain the current position of the piston 136 from the sensor 502. Further, the processor 210 may retrieve an information I5 related to the previous position of the piston 136 from the memory 208. Furthermore, the processor 210 may determine the movement of the piston 136 based on the comparison between the current position and the previous position.

It should be noted that data from the linear position sensor may be used in combination with other sensors, such as, the pulse RADAR sensor (i.e., the sensor 202, 204 of FIG. 2), the laser displacement sensor, the ultrasound sensor, the imaging device, or the inductive position sensor to determine if the tension in the track 118 has reduced. For example, if any one of the pulse RADAR sensor, the laser displacement sensor, the ultrasound sensor, the imaging device, or the inductive position sensor determines that the tension in the track 118 is low and the piston 136 has moved backward due to bleeding oil from the actuator 134, then there may be more confidence that the tension in the track 118 is low. Thus, the movement of the piston 136 may be an indication of the decrease in the tension in the track 118. In an example, a number of hours elapsed since the last adjustment of the piston 136 could also be used to determine that the tension in the track 118 is below the tension threshold because the tension may reduce due to wear of one or more components of the undercarriage system 116.

Further, when the sensor 502 includes the linear position sensor, the processor 210 may determine an amount by which the tension has reduced based on a distance by which the piston 136 has moved from its previous position. It should be noted that the processor 210 may determine the distance by which the piston 136 has moved from its previous position based on the comparison between the current position and the previous position.

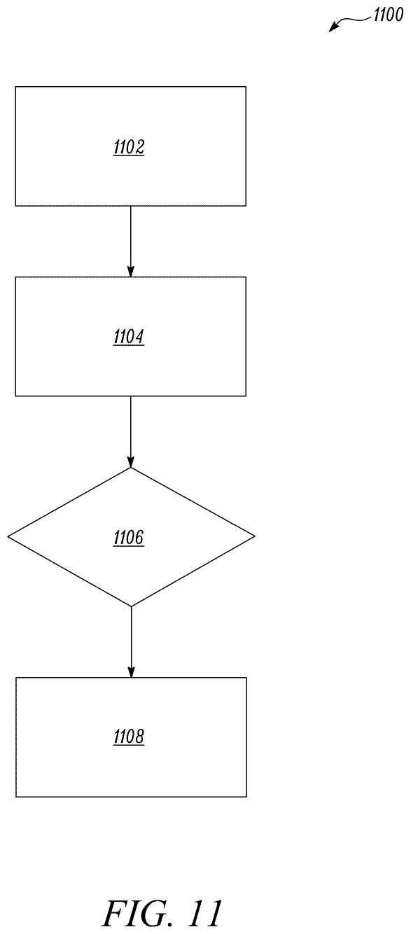

FIG. 11 illustrates a process (or an algorithm) flowchart 1100 for monitoring the tension in the track 118 of the work machine 100. The process 1100 explains an implementation of the system 500 illustrated in FIG. 9. Referring to FIGS. 9 to 11, the process 1100 may be stored in the memory 208 of the controller 206 and retrieved for execution by the processor 210 of the controller 206.

At a block 1102, the processor 210 obtains the current position of the piston 136 from the sensor 502. At a block 1104, the processor 210 retrieves the previous position of the piston 136 from the memory 208. At a block 1106, the processor 210 compares the current position of the piston 136 with the previous position of the piston 136. The processor 210 determines that the tension in the track 118 is below the tension threshold if the current position of the piston 136 is different from the previous position of the piston 136. If the processor 210 determines that the tension in the track 118 is below the tension threshold, the processor 210 moves to a block 1108 to generate the notification N2.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure describes the system 200, 500 for monitoring the tension in the track 118 of the work machine 100. The system 200, 500 described herein may ensure that the tracks 118 are disposed at an optimum track tension, which may in turn reduce wear of the tracks 118 and/or other undercarriage components and may also provide a longer track life. Further, the system 200, 500 may ensure that the tracks 118 are operated at their optimum capability. The system 200, 500 may provide the notification N1, N2 to operators when the tension in the track 118 reduces. Accordingly, the operators may service the tracks 118 to reinstate the tracks 118 to the optimum track tension.

The system 200, 500 may be retrofitted on existing work machines with minimum modifications. In some examples, the sensors 202, 204, 502, 504 may be chosen such that the sensors 202, 204, 502, 504 can determine the decrease in the tension in the track 118 despite of dirt build-up in the undercarriage system 116. Further, the sensors 202, 204, 502, 504 are embodied as non-invasive sensors, and do not affect an operation of the tracks 118.

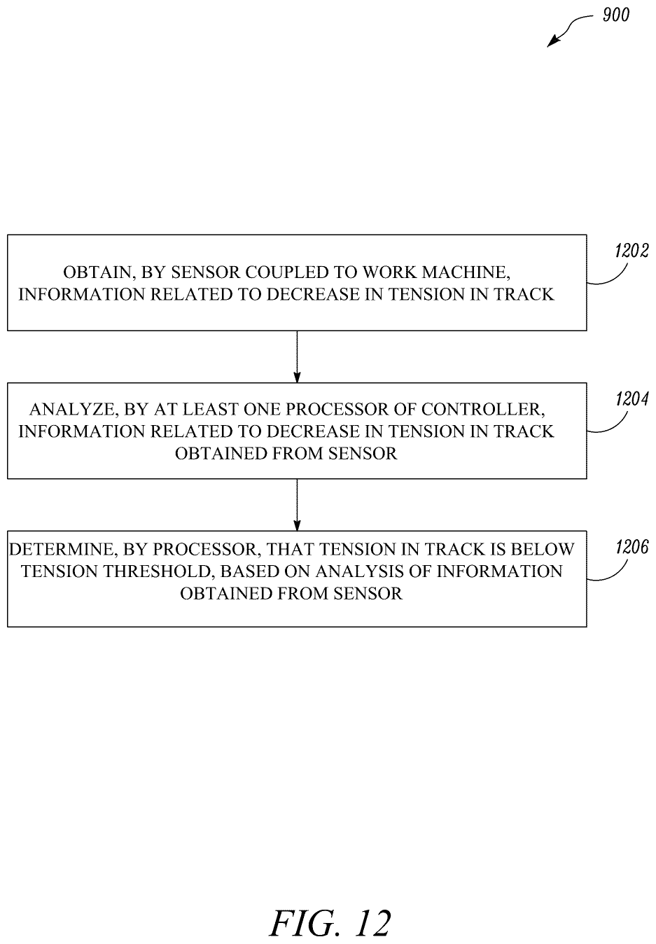

FIG. 12 is a flowchart for a method 1200 for monitoring the tension in the track 118 of the work machine 100. Referring to FIGS. 1 to 12, at step 1202, the sensor 202, 204, 502, 504 coupled to the work machine 100 obtains the information I1, I2, I3, I4 related to the decrease in the tension in the track 118. The sensor 202, 204, 502, 504 includes the pulse RADAR sensor, the laser displacement sensor, the ultrasound sensor, the imaging device, the inductive position sensor, or the linear position sensor associated with the actuator 134 of the work machine 100 that adjusts the tension in the track 118.

At step 1204, the one or more processor 210 of the controller 206 analyze the information I1, I2, I3, I4 related to the decrease in the tension in the track 118 obtained from the sensor 202, 204, 502, 504.

At step 1206, the processor 210 determines that the tension in the track 118 is below the tension threshold, based on the analysis of the information I1, I2, I3, I4 obtained from the sensor 202, 204, 502, 504.

In an example, when the sensor 202, 204, 502, 504 includes the pulse RADAR sensor, the laser displacement sensor, the ultrasound sensor, the imaging device, or the inductive position sensor, the information I1, I2, I3, I4 obtained from the sensor 202, 204, 502, 504 is related to the distance D1, D2, E1, E2 between the sensor 202, 204, 502, 504 and the track 118 of the work machine 100. Further, the method 1200 includes a step at which the processor 210 determines the actual distance D5, E5 between the sensor 202, 204, 502, 504 and the track 118 of the work machine 100, based on the information I1, I2, I3, I4 obtained from the sensor 202, 204, 502, 504. Furthermore, the method 1200 also includes a step at which the processor 210 determines that the tension in the track 118 is below the tension threshold based on the actual distance D5, E5 being different than the expected distance D3, D4, E3, E4 between the sensor 202, 204, 502, 504 and the track 118 of the work machine 100. The memory 208 stores the expected distance D3, D4, E3, E4 between the sensor 202, 204, 502, 504 and the track 118 of the work machine 100.

In another example, when the sensor 502 includes the linear position sensor, the sensor 502 is communicably coupled with the actuator 134. The actuator 134 includes the piston 136. Further, when the sensor 502 includes the linear position sensor, the information I3 obtained from the sensor 502 is related to the movement of the piston 136 from its previous position. Furthermore, the method 1200 includes a step at which the processor 210 determines that the tension in the track 118 is below the tension threshold based on the movement of the piston 136 from its previous position.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A system for monitoring a tension in a track of a work machine, the system comprising:
one or more sensors coupled to the work machine, wherein a sensor, of the one or more sensors, is configured to obtain a distance information related to a distance between the sensor and the track of the work machine, and wherein the sensor includes a pulse Radio Detection and Ranging (RADAR) sensor; and
a controller including at least one memory and at least one processor communicably coupled with the memory and the sensor, wherein the memory is configured to store an expected distance between the sensor and the track of the work machine, and wherein the processor is configured to:
determine an actual distance between the sensor and the track of the work machine, based on the distance information obtained from the sensor; and
determine, based on the actual distance being greater than the expected distance, that the tension in the track is below a tension threshold.

2. The system of claim 1, wherein the sensor is coupled to a frame of the work machine.

3. The system of claim 1, wherein the sensor includes at least one of:
a first sensor configured to obtain a first distance information related to a first distance between the first sensor and a first portion of the track of the work machine; and
a second sensor configured to obtain a second distance information related to a second distance between the second sensor and a second portion of the track of the work machine, wherein the first portion is spaced apart from the second portion.

4. The system of claim 3, wherein the processor is configured to:
determine a first actual distance between the first sensor and the first portion of the track of the work machine, based on the first distance information;
determine a second actual distance between the second sensor and the second portion of the track of the work machine, based on the second distance information; and
determine that the tension in the track is below the tension threshold based on at least one of:
the first actual distance being greater than a first expected distance between the sensor and the track of the work machine; and
the second actual distance being greater than a second expected distance between the sensor and the track of the work machine.

5. The system of claim 4, wherein the processor is configured to determine the actual distance by averaging the first actual distance and the second actual distance.

6. The system of claim 1, wherein the processor is configured to generate a notification to alert an operator that the tension in the track is below the tension threshold.

7. The system of claim 1, wherein the processor is configured to determine an amount of the tension in the track based on a value of deviation between the actual distance and the expected distance.

8. A system for monitoring a tension in a track of a work machine, the system comprising:
one or more sensors coupled to the work machine, wherein a sensor, of the one or more sensors, is configured to obtain an information related to a decrease in the tension in the track, and wherein the sensor includes a laser displacement sensor, an ultrasound sensor, an imaging device, an inductive position sensor, or a linear position sensor associated with an actuator of the work machine that is adapted to adjust the tension in the track; and
a controller including at least one memory and at least one processor communicably coupled with the memory and the sensor, wherein the processor is configured to:
analyze the information related to the decrease in the tension in the track obtained from the sensor; and
determine, based on an analysis of the information obtained from the sensor, that the tension in the track is below a tension threshold.

9. The system of claim 8, wherein, when the sensor includes the laser displacement sensor, the ultrasound sensor, the imaging device, or the inductive position sensor, the information obtained from the sensor relates to a distance between the sensor and the track of the work machine, and wherein the processor is configured to:
determine an actual distance between the sensor and the track of the work machine, based on the information obtained from the sensor; and
determine, based on the actual distance being different than an expected distance between the sensor and the track of the work machine, that the tension in the track is below the tension threshold, wherein the memory is configured to store the expected distance between the sensor and the track of the work machine.

10. The system of claim 9, wherein the processor is configured to determine an amount of the tension in the track based on a value of deviation between the actual distance and the expected distance.

11. The system of claim 9, wherein, when the sensor includes the laser displacement sensor, the ultrasound sensor, the imaging device, or the inductive position sensor, the sensor includes at least one of:
a first sensor configured to obtain a first distance information related to a first distance between the first sensor and a first portion of the track of the work machine; and
a second sensor configured to obtain a second distance information related to a second distance between the second sensor and a second portion of the track of the work machine, wherein the first portion is spaced apart from the second portion.

12. The system of claim 11, wherein, when the sensor includes the laser displacement sensor, the ultrasound sensor, the imaging device, or the inductive position sensor, the processor is configured to:
determine a first actual distance between the first sensor and the first portion of the track of the work machine, based on the first distance information;
determine a second actual distance between the second sensor and the second portion of the track of the work machine, based on the second distance information; and
determine that the tension in the track is below the tension threshold based on at least one of:
the first actual distance being different than a first expected distance between the sensor and the track of the work machine; and
the second actual distance being different than a second expected distance between the sensor and the track of the work machine.

13. The system of claim 12, wherein the processor is configured to determine the actual distance by averaging the first actual distance and the second actual distance.

14. The system of claim 8, wherein the processor is configured to generate a notification to alert an operator that the tension in the track is below the tension threshold.

15. The system of claim 8, wherein, when the sensor includes the laser displacement sensor, the ultrasound sensor, the sensor is coupled to a frame of the work machine, and wherein, when the sensor includes the inductive position sensor, the sensor is disposed in an undercarriage system of the work machine, such that the sensor faces the track.

16. The system of claim 8, wherein, when the sensor includes the linear position sensor, the sensor is communicably coupled with the actuator, and wherein the actuator includes a piston.

17. The system of claim 16, wherein, when the sensor includes the linear position sensor, the information obtained from the sensor is related to a movement of the piston from its previous position, and wherein the processor is configured to determine that the tension in the track is below the tension threshold based on the movement of the piston from its previous position.

18. A method for monitoring a tension in a track of a work machine, the method comprising:
obtaining, by a sensor coupled to the work machine, an information related to a decrease in the tension in the track, wherein the sensor includes a pulse Radio Detection and Ranging (RADAR) sensor, a laser displacement sensor, an ultrasound sensor, an imaging device, an inductive position sensor, or a linear position sensor associated with an actuator of the work machine that is adapted to adjust the tension in the track;
analyzing, by at least one processor of a controller, the information related to the decrease in the tension in the track obtained from the sensor; and
determining, by the processor, that the tension in the track is below a tension threshold, based on an analysis of the information obtained from the sensor.

19. The method of claim 18, wherein, when the sensor includes the pulse RADAR sensor, the laser displacement sensor, the ultrasound sensor, the imaging device, or the inductive position sensor, the information obtained from the sensor is related to a distance between the sensor and the track of the work machine, the method further comprising:
determining, by the processor, an actual distance between the sensor and the track of the work machine, based on the information obtained from the sensor;
and
determining, by the processor, that the tension in the track is below the tension threshold based on the actual distance being different than an expected distance between the sensor and the track of the work machine, wherein a memory of the controller is configured to store the expected distance between the sensor and the track of the work machine.

20. The method of claim 18, wherein, when the sensor includes the linear position sensor, the sensor is communicably coupled with the actuator, wherein the actuator includes a piston, and wherein, when the sensor includes the linear position sensor, the information obtained from the sensor is related to a movement of the piston from its previous position, the method further comprising:
determining, by the processor, that the tension in the track is below the tension threshold based on the movement of the piston from its previous position.
